(19) United States
(12) Patent Application Publication
(10) Pub. No.: US 2021/0071598 A1
(43) Pub. Date: Mar. 11, 2021

(54) EVAPORATED FUEL TREATMENT APPARATUS

(71) Applicant: AISAN KOGYO KABUSHIKI KAISHA, Obu-shi (JP)

(72) Inventor: Makoto Nakagawa, Nagoya-shi (JP)

(73) Assignee: AISAN KOGYO KABUSHIKI KAISHA, Obu-shi (JP)

(21) Appl. No.: 17/001,836

(22) Filed: Aug. 25, 2020

(30) Foreign Application Priority Data
Sep. 6, 2019 (JP) 2019-163123
Jul. 17, 2020 (JP) 2020-123170

(51) Int. Cl. F02D 41/00; F02M 25/08; F02M 35/10; B01D 53/04

(52) U.S. Cl. CPC F02D 41/003; F02M 25/0836; F02M 35/10222; B01D 53/0415; B01D 2259/4516; B01D 53/0454; F02D 2200/0414; F02D 2200/0606; B01D 2259/40086; B01D 53/0446

(57) ABSTRACT

An evaporated fuel treatment apparatus calculates concentration of purge gas from the characteristics of density of purge gas and the characteristics of a pump discharge pressure with respect to two butane ratios that have been stored in advance and a detected value of the pump discharge pressure detected by a pressure sensor, calculates concentration of purge gas by correcting the concentration of the purge gas based on an A/F detected value in an engine such that a controller controls an open degree of a purge valve and a pump speed of a purge pump during execution of purge control based on the concentration of the purge gas.

### CROSS-REFERENCE TO RELATED APPLICATIONS

This application is based upon and claims the benefit of priority from the prior Japanese Patent Applications No. 2019-163123, filed Sep. 6, 2019 and No. 2020-123170, filed Jul. 17, 2020, the entire contents of which are incorporated herein by reference.

### BACKGROUND

### Technical Field

The present disclosure is related to an evaporated fuel treatment apparatus to introduce evaporated fuel generated in a fuel tank into an engine for treatment.

### Related Art

As a conventional technique related to an evaporated fuel treatment apparatus, Patent Document 1 describes a technique of estimating actual concentration of purge gas based on the P-Q characteristics and the ΔP-ρ characteristics of air and a specified component (such as 100% butane-contained air) that have been stored in advance and controlling a flow volume of the purge gas based on the thus estimated value.

### RELATED ART DOCUMENTS

### Patent Documents

Japanese Patent No. 6332836

### SUMMARY

### Technical Problems

However, the actual purge gas includes other components than the specified component, which could cause divergence in the P-Q characteristics and the ΔP-ρ characteristics, and thereby estimation accuracy in the purge gas concentration may be degraded. This could further lead to occurrence of A/F disturbance (i.e., air-fuel ratio disturbance in which the air-fuel ratio in a combustion chamber of an engine excessively fluctuates).

The present disclosure has been made to solve the above problem and has a purpose of providing an evaporated fuel treatment apparatus that can suppress occurrence of A/F disturbance.

### Means of Solving the Problems

One aspect of the present disclosure for solving the above problem provides an evaporated fuel treatment apparatus comprising: a canister configured to store evaporated fuel; a purge passage configured to make purge gas including the evaporated fuel flow from the canister to an engine; a purge valve configured to open and close the purge passage; and a controller configured to drive the purge valve to execute purge control of introducing the purge gas into the engine through the purge passage and an intake passage from the canister, wherein the evaporated fuel treatment apparatus includes a purge gas concentration detection part to detect a concentration of the purge gas, the purge gas concentration detection part calculates the concentration of the purge gas and detects the purge gas concentration by correcting the calculated concentration of the purge gas based on an A/F detected value in the engine, and the controller controls an open degree of the purge valve during execution of the purge control based on the concentration of the purge gas that is detected by the purge gas concentration detection part.

According to this aspect, the purge gas concentration is corrected based on the A/F detected value in the engine, thus improving detection accuracy of the purge gas concentration. Accordingly, controlling the purge valve based on the thus detected purge gas concentration makes it possible to control the purge valve based on the actual purge gas concentration, thus achieving suppression of occurrence of the A/F disturbance.

In the above aspect, preferably, the evaporated fuel treatment apparatus comprises: a purge pump configured to feed the purge gas to the intake passage; and a pump pressure detection part to detect a pump pressure as any one of a discharge pressure and a front-rear pressure difference of the purge pump, wherein the purge gas concentration detection part calculates the concentration of the purge gas from density characteristics of the purge gas and characteristics of the pump pressure with respect to a plurality of specified fuel component ratios that have been stored in advance, the specified fuel component ratio being defined by a ratio of a specified component of the evaporated fuel included in the purge gas, and from a detected value of the pump pressure detected by the pump pressure detection part, the controller carries out the purge control by driving the purge pump and the purge valve, and the controller controls an open degree of the purge valve and a pump speed of the purge pump during execution of the purge control based on the concentration of the purge gas that is detected by the purge gas concentration detection part.

In a conventional method, a temperature sensor is provided in a purge passage and a density of the purge gas is corrected based on a detected value detected by this temperature sensor to obtain the purge gas concentration. In this conventional method, however, even though the detection accuracy is not degraded in detection of the purge gas concentration in a steady state (in a state in which the purge gas continuously and steadily flows), the detection accuracy could be degraded when flowing and not-flowing of the purge gas is repeated in the purge passage since the temperature sensor provided in the purge passage has inferior temperature-tracking-performance and thus the detection accuracy is poor.

In the above aspect, preferably, the purge gas concentration detection part is configured to correct the calculated concentration of the purge gas based on a pump inside temperature that is a temperature inside the purge pump.

According to this aspect, the purge gas concentration can be detected in consideration with influence of changes in the purge gas density due to changes in the pump inside temperature, thus further improving the detection accuracy of the purge gas concentration. Further, even when operation of flowing and not-flowing of the purge gas in the purge passage is repeated, the pump inside temperature is hardly influenced by this repetitive operation, and thus the detection accuracy of the purge gas concentration is further improved.

Another aspect of the present disclosure to solve the above problem is to provide an evaporated fuel treatment apparatus comprising: a canister configured to store evaporated fuel; a purge passage configured to make purge gas including the evaporated fuel flow from the canister to an engine; a purge pump configured to feed the purge gas to an intake passage; a purge valve configured to open and close the purge passage; and a controller configured to drive the purge pump and the purge valve to execute purge control of introducing the purge gas to the engine through the purge passage and the intake passage from the canister, wherein the evaporated fuel treatment apparatus includes: a pump pressure detection part to detect a pump pressure as any one of a discharge pressure and a front-rear pressure difference of the purge pump; and a purge gas concentration detection part to detect concentration of the purge gas, the purge gas concentration detection part calculates the concentration of the purge gas from a detected value of the pump pressure detected by the pump pressure detection part, the purge gas concentration detection part detects the concentration of the purge gas by correcting the calculated concentration of the purge gas based on a pump inside temperature that is a temperature inside the purge pump, and the controller controls an open degree of the purge valve and a pump speed of the purge pump during execution of the purge control based on the concentration of the purge gas that is detected by the purge gas concentration detection part.

According to this aspect, the purge gas concentration can be detected in consideration with influence of changes in density of the purge gas due to changes in the pump inside temperature, thus improving the detection accuracy of the purge gas concentration. Further, even when operation of flowing and not-flowing of the purge gas in the purge passage is repeated, the pump inside temperature is hardly influenced, and thus the detection accuracy of the purge gas concentration is further improved. Accordingly, controlling the purge valve based on the detected purge gas concentration makes it possible to control the purge valve based on the actual purge gas concentration, thereby preventing the A/F disturbance.

In the above aspect, preferably, the controller disallows controlling the open degree of the purge valve or both the open degree of the purge valve and the pump speed of the purge pump during execution of the purge control based on the concentration of the purge gas when the concentration of the purge gas is equal to or less than a predetermined concentration.

According to this aspect, the A/F disturbance hardly occurs in a low purge-gas-concentration region which has a possibility of lowering the detection accuracy of the purge gas concentration.

In the above aspect, preferably, the controller sets an upper limit to a reduction rate of an injection amount of an injector that is configured to inject fuel into the engine.

According to this aspect, the A/F disturbance is further effectively prevented from occurring.

In the above aspect, preferably, the evaporated fuel treatment apparatus comprises a pump inside temperature estimation part to estimate the pump inside temperature from an operation information of the purge pump.

According to this aspect, the purge pump inside temperature can be detected without providing a temperature sensor in the purge pump. Therefore, the purge pump can be simplified to reduce the cost.

In the above aspect, preferably, the controller is configured to calibrate a detected value of the pump pressure detected by the pump pressure detection part based on the P-Q characteristics of the purge pump under a state in which the concentration of the purge gas calculated from an A/F detected value in the engine is almost zero.

According to this aspect, even when there is occurred individual differences and secular changes in the pump pressure detection part, the pump pressure detection part can maintain its accuracy in the detected value of the pump pressure, and thus the detection accuracy of the purge gas concentration is stabilized.

In the above aspect, preferably, the purge gas concentration detection part is configured to calculate the concentration of the purge gas from a detected value of any one of a thermal conductive type sensor and an ultrasonic-wave type sensor.

In the above aspect, preferably, the controller is configured to: discontinue controlling the open degree of the purge valve when any one of changes in a temperature of intake air in the intake passage and changes in a temperature of fuel in a fuel tank are within a predetermined range during a certain period of time; and restart controlling the open degree of the purge valve when any one of the changes in the temperature of the intake air in the intake passage and the changes in the temperature of the fuel in the fuel tank exceed the predetermined range.

According to the above aspects, the required electricity can be reduced.

According to an evaporated fuel treatment apparatus of the present disclosure, the A/F disturbance can be hardly generated.

### BRIEF DESCRIPTION OF THE DRAWINGS

FIG. 1 is a schematic view showing an overall configuration of an engine system including an evaporated fuel treatment apparatus in a first embodiment;

FIG. 2 is a sectional view of a purge pump;

FIG. 3 is a graph showing one example of the density characteristics of purge gas in each butane content ratio and another example of the density characteristics of purge gas in each content ratio of other fuel components;

FIG. 4 is a flowchart showing a method of detecting concentration of the purge gas in a first example of the first embodiment;

FIG. 5 is a table showing one example of a map prescribing a relation between an absolute pressure and density;

FIG. 6 is a table showing another example of a map prescribing a relation between the absolute pressure and the density;

FIG. 7 is a table showing one example of the characteristics of pump discharge pressure in each butane content ratio;

FIG. 8 is a table showing one example of a map prescribing a relation between a pump speed and a pressure;

FIG. 9 is a time chart showing one example of a control operation carried out in the first example of the first embodiment;

FIG. 10 is a flowchart showing a method of detecting concentration of the purge gas in a second example of the first embodiment;

FIG. 11 is a table showing one example of a map prescribing a relation between a pump inside temperature and the density;

FIG. 12 is a table showing another example of a map prescribing a relation between the pump inside temperature and the density;

FIG. 13 is a table showing one example of a map prescribing a relation among the pump speed, an ambient temperature, and a hardware temperature per unit of time;

FIG. 14 is a table showing one example of a map prescribing a relation among the pump speed, a flow volume of the purge gas, and the hardware temperature per unit of time;

FIG. 15 is a flowchart showing a method of detecting concentration of the purge gas in a third example of the first embodiment;

FIG. 16 is a schematic view showing an overall configuration of an engine system including an evaporated fuel treatment apparatus in a second embodiment;

FIG. 17 is a flowchart showing a method of detecting concentration of the purge gas in the second embodiment;

FIG. 18 is a schematic view showing an overall configuration of an engine system including an evaporate fuel treatment apparatus in a modified example of the second embodiment; and

FIG. 19 is a flowchart showing a method of detecting concentration of the purge gas in the modified example of the second embodiment.

### DETAILED DESCRIPTION OF THE EXEMPLARY EMBODIMENTS

One embodiment of an evaporated fuel treatment apparatus embodying the present disclosure is explained in detail with reference to the accompanying drawings. The following embodiment is explained with exemplifying an evaporated fuel treatment apparatus of the present disclosure to an engine system mounted on a vehicle such as an automobile.

### First Embodiment

Firstly, a first embodiment is explained.

### <Overall Configuration of System>

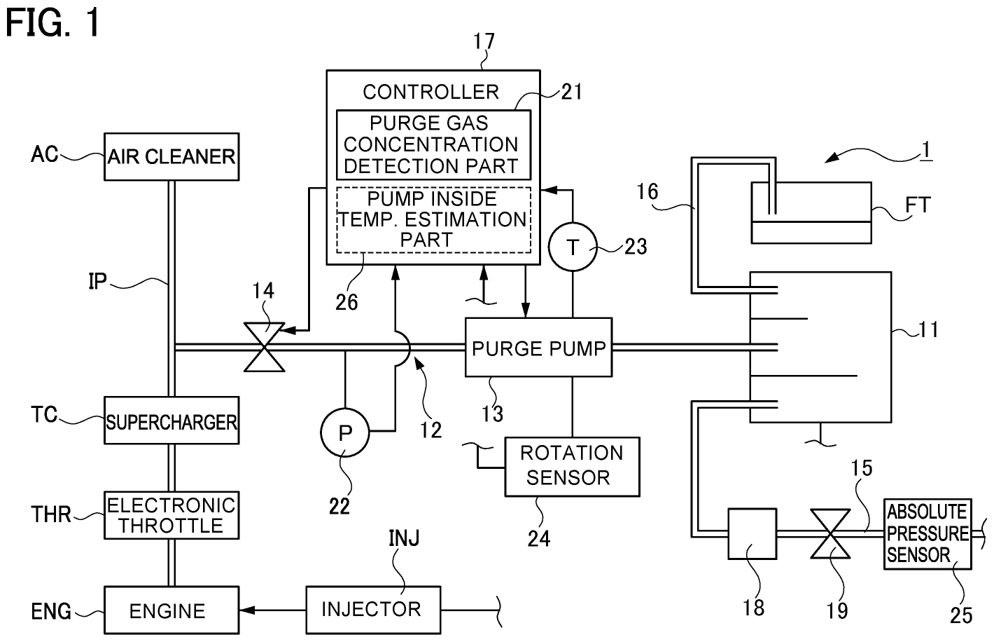

An engine system applied with an evaporated fuel treatment apparatus 1 of the present embodiment is mounted on a vehicle such as an automobile and as shown in FIG. 1, is provided with an engine ENG. This engine ENG is connected with an intake passage IP to supply air (intake air or inhale air) to the engine ENG. The intake passage IP is provided with an electronic throttle THR (a throttle valve) to regulate an amount of the air (intake air amount) flowing into the engine ENG by opening and closing the intake passage IP and a supercharger TC to increase density of the air flowing into the engine ENG. On an upstream side (an upstream side in an intake-air flowing direction) of the electronic throttle THR in the intake passage IP, there is provided an air cleaner AC to remove foreign matters from the air which is to be flown into the intake passage IP. Thus, air passes through the air cleaner AC and is taken into the engine ENG via the intake passage IP.

The evaporated fuel treatment apparatus 1 of the present embodiment is an apparatus for introducing an evaporated fuel in a fuel tank FT into the engine ENG via the intake passage IP in the above-mentioned engine system. This evaporated fuel treatment apparatus 1 includes a canister 11, a purge passage 12, a purge pump 13, a purge valve 14, an atmosphere passage 15, a vapor passage 16, a controller 17, a filter 18, an atmosphere cut-off valve 19, and others.

The canister 11 is connected to the fuel tank FT via the vapor passage 16 to temporarily store the evaporated fuel that is to be made flowing into the canister 11 from the fuel tank FT through the vapor passage 16. The canister 11 is further communicated with the purge passage 12 and the atmosphere passage 15.

The purge passage 12 is connected to the intake passage IP and the canister 11. Thus, purge gas (gas including the evaporated fuel) having flown out of the canister 11 flows through the purge passage 12 to be introduced into the intake passage IP.

The purge pump 13 is provided in the purge passage 12 to regulate the flow of the purge gas flowing through the purge passage 12. To be specific, the purge pump 13 feeds the purge gas inside the canister 11 to the purge passage 12 and then feeds the purge gas having fed into the purge passage 12 to the intake passage IP.

The purge valve 14 is provided in the purge passage 12 at a position downstream (a downstream side in a flow direction of the purge gas during execution of purge control) of the purge pump 13, namely between the purge pump 13 and the intake passage IP. The purge valve 14 opens and closes the purge passage 12. During valve-closing of the purge valve 14 (in a state in which the valve is closed), flow of the purge gas in the purge passage 12 is halted by the purge valve 14 so that the purge gas does not flow into the intake passage IP. On the other hand, during valve-opening of the purge valve 14 (in a state in which the valve is open), the purge gas flows into the intake passage IP.

The purge valve 14 is to carry out a duty control of continuously switching its open state and its closed state according to a duty ratio that is determined by an operation state of the engine. In the open state, the purge passage 12 is opened to communicate the canister 11 with the intake passage IP. In the closed state, the purge passage 12 is closed to shut off communication of the canister 11 with the intake passage IP on the purge passage 12. The duty ratio represents a ratio of a term of open state in one combination of the open state and the closed state while the open state and the closed state are continuously switched. The purge valve 14 is to regulate a flow volume of the purge gas by adjusting the duty ratio (namely, a term or length of the open state).

The atmosphere passage 15 has one end opening in the atmosphere and the other end connected to the canister 11 so that the canister 11 is communicated with the atmosphere. To this atmosphere passage 15, the air taken from the atmosphere flows in. The atmosphere passage 15 is provided with the filter 18 and the atmosphere cut-off valve 19. The filter 18 is to remove foreign matters from the atmosphere (the air) flowing into the atmosphere passage 15. The atmosphere cut-off valve 19 is to open and close the atmosphere passage 15.

The vapor passage 16 is connected to the fuel tank FT and the canister 11. Thus, the evaporated fuel in the fuel tank FT flows into the canister 11 through the vapor passage 16.

The controller 17 is a part of an ECU (not shown) mounted on a vehicle and is integrally arranged with other parts or components (such as a unit controlling the engine ENG) of the ECU. The controller 17 may be otherwise arranged separately from other parts of the ECU. The controller 17 includes a CPU and memories such as ROM, an RAM, or the like. The controller 17 controls the evaporated fuel treatment apparatus 1 and an engine system according to programs stored in advance in the memories. For example, the controller 17 controls the purge pump 13 and the purge valve 14.

In the present embodiment, the controller 17 is provided with a purge gas concentration detection part 21. The purge gas concentration detection part 21 detects concentration of the purge gas flowing through the purge passage 12. The purge gas concentration detection part 21 may be provided independently from the controller 17.

Further, the evaporated fuel treatment apparatus 1 of the present embodiment includes a pressure sensor 22. The pressure sensor 22 is provided in the purge passage 12 on a downstream side of the purge pump 13 (specifically, a position between the purge pump 13 and the purge valve 14). The pressure sensor 22 is to detect a pump discharge pressure P that is a discharge pressure of the purge pump 13. This pressure sensor 22 corresponds to one example of a “pump pressure detection part” of the present disclosure. The pump discharge pressure P corresponds to one example of a “pump pressure” of the present disclosure.

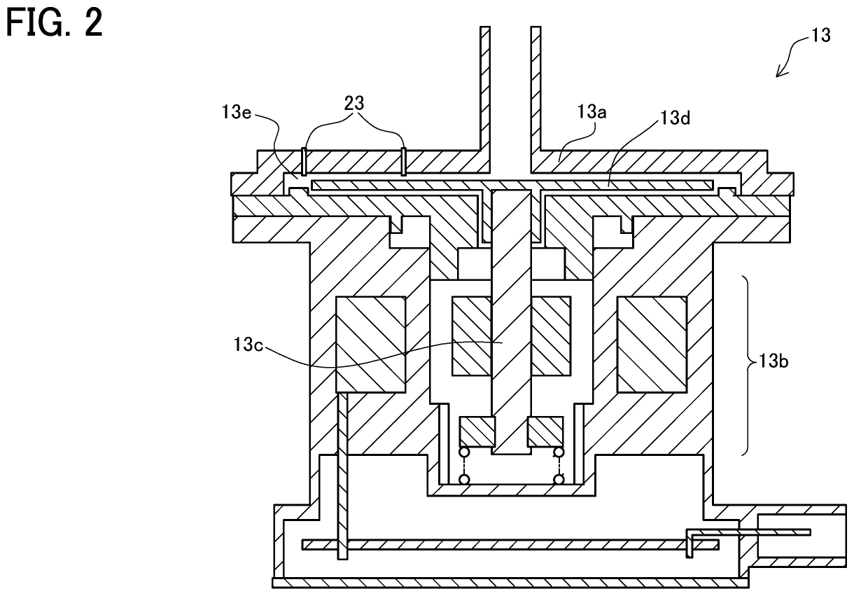

Further, the evaporated fuel treatment apparatus 1 of the present embodiment includes a temperature sensor 23. This temperature sensor 23 is, for example, provided inside the purge pump 13 as shown in FIG. 2 to detect a pump inside temperature that is a temperature inside the purge pump 13. In an example shown in FIG. 2, the temperature sensor 23 is provided inside a pump cover 13a and inside a volute chamber 13e which is a space where an impeller 13d is connected to a shaft 13c of a motor section 13b in the purge pump 13.

Further, as shown in FIG. 1, the evaporated fuel treatment apparatus 1 of the present embodiment includes a rotation sensor 24. The rotation sensor 24 is to detect a pump speed as a pump rotation speed of the purge pump 13.

Further, the evaporated fuel treatment apparatus 1 of the present embodiment includes an absolute pressure sensor 25. The absolute pressure sensor 25 is provided in the atmosphere passage 15 connected to the canister 11. This absolute pressure sensor 25 is to detect the atmospheric pressure (the absolute pressure).

In the evaporated fuel treatment apparatus 1 having the above-mentioned configuration, when a purge condition is satisfied during operation of the engine ENG, the controller 17 controls the purge pump 13 and the purge valve 14, more specifically, drives the purge pump 13 to open the purge valve 14 and thus executes the purge control. This purge control is a control operation of introducing purge gas into the engine ENG through the purge passage 12 and the intake passage IP from the canister 11.

While the purge control is being carried out, the engine ENG is supplied with the air taken into the intake passage IP, fuel injected through an injector INJ from the fuel tank FT, and the purge gas supplied to the intake passage IP by this purge control. The controller 17 adjusts a term of injection by the injector INJ and a term of valve-opening of the purge valve 14 to adjust an air-fuel ratio (A/F) of the engine ENG to an optimum air-fuel ratio (for example, an ideal air-fuel ratio).

### <Method of Detecting Purge Gas Concentration>

Next, a method of detecting purge gas concentration detected by the purge gas concentration detection part 21 is explained.

### First Example

A first example is firstly explained.

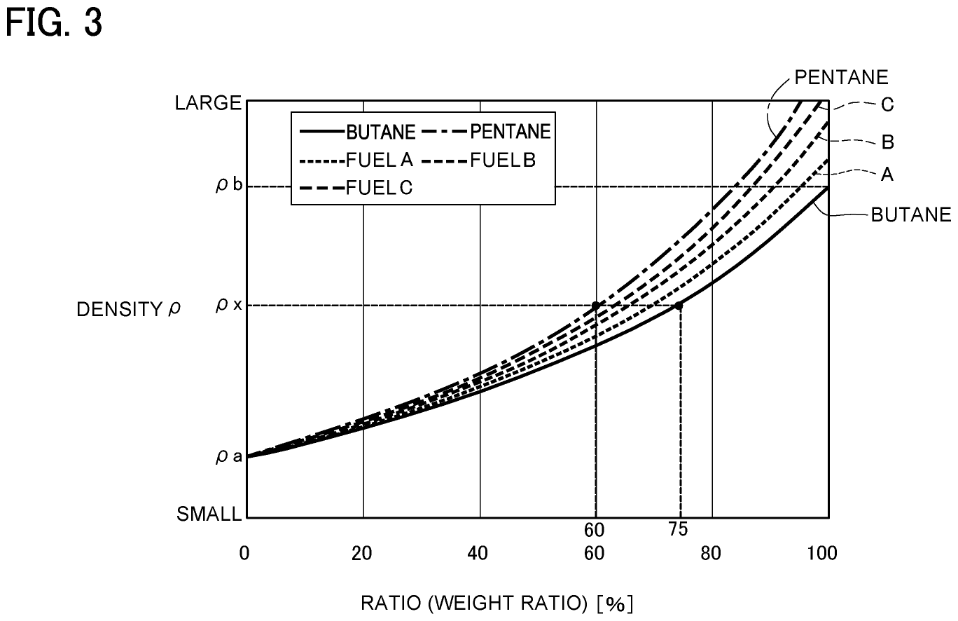

As shown in FIG. 3, when the property of the evaporated fuel included in the purge gas (hereinafter, simply referred to “fuel”) changes, fuel component ratio could be changed even if the density p of the purge gas is same (for example, p=px in the figure). As a result of this change, when the density p of the purge gas is obtained from the pump discharge pressure P and the purge gas concentration is calculated from this purge gas density p, detection accuracy in detecting the purge gas concentration could decline.

For example, one example of calculating a fuel amount per unit volume (for example, per 1 L (litter)) is considered by the following formula.

(Density ρ)×(Ratio(Weight ratio))×(Volume)=(Fuel amount) (Formula 1)

According to the above formula, when the density ρ=ρx (see FIG. 3)=2.0 g/L and the volume=1.0 L, each fuel amount in a case of pentane ratio=60% and a case of butane ratio=75% results in a fuel amount of pentane=1.2 g and a fuel amount of butane=1.5 g, respectively. As mentioned above, there is a large gap in the fuel amount in the purge gas per unit volume in a case that the fuel property of the purge gas is pentane and a case that the fuel property of the purge gas is butane.

In the present embodiment, when a ratio of butane (that is the specified component of the evaporated fuel) included in the purge gas is defined as the butane ratio, the purge gas concentration detection part 21 calculates the purge gas concentration from the characteristics of the purge gas density p and the characteristics of the pump discharge pressure P with respect to a plurality of (for example, two) butane ratios that are stored in advance and from a detected value Pmix of the pump discharge pressure detected by the pressure sensor 22. The purge gas concentration detection part 21 further corrects the calculated purge gas concentration based on an A/F detected value in the engine ENG.

### (Explanation of Flowchart for Method of Detecting Purge Gas Concentration)

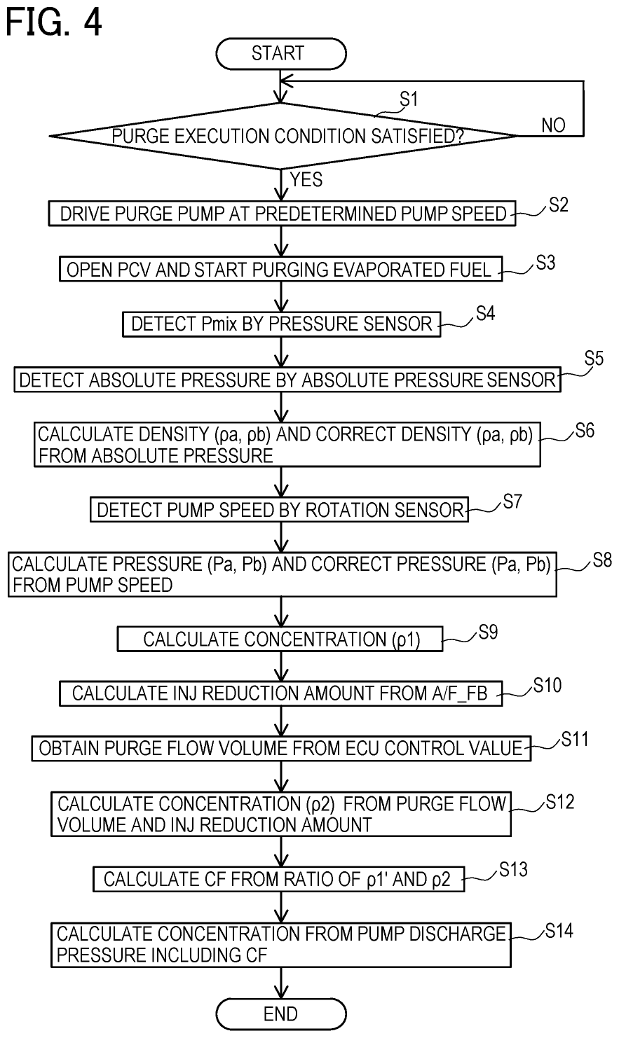

Specifically, in the present embodiment, the purge gas concentration is detected according to the operation indicated in the flowchart of FIG. 4, and the purge control is carried out based on the detected purge gas concentration. As shown in FIG. 4, when a purge execution condition is satisfied (step S1: YES), the controller 17 drives the purge pump 13 at a predetermined pump speed (step S2) and starts purging (the purge control) the evaporated fuel by opening the purge valve 14 (denoted as “PCV” in the figure) (step S3).

Subsequently, the purge gas concentration detection part 21 detects the detected value Pmix of the pump discharge pressure by the pressure sensor 22 (step S4) and detects the absolute pressure (atmospheric pressure) by the absolute pressure sensor 25 (step S5).

Subsequently, the purge gas concentration detection part 21 calculates a density ρa and a density ρb and corrects the density pa and the density ρb from the detected absolute pressure (step S6).

Herein, the density pa and the density ρb represent characteristics of the purge gas density ρ in different butane ratios stored in advance in the purge gas concentration detection part 21. For example, the density pa represents the purge gas density ρ in a case where the butane ratio is 0% (i.e., ratio of the air is 100%), and the density ρb represents the purge gas density ρ in a case where the butane ratio is 100%. The purge gas concentration detection part 21 in this example calculates the density pa and the density ρb by use of a map shown in FIG. 3, for example. The butane ratio means a weight ratio of butane included in the purge gas and corresponds to one example of a “specified fuel component ratio” of the present disclosure.

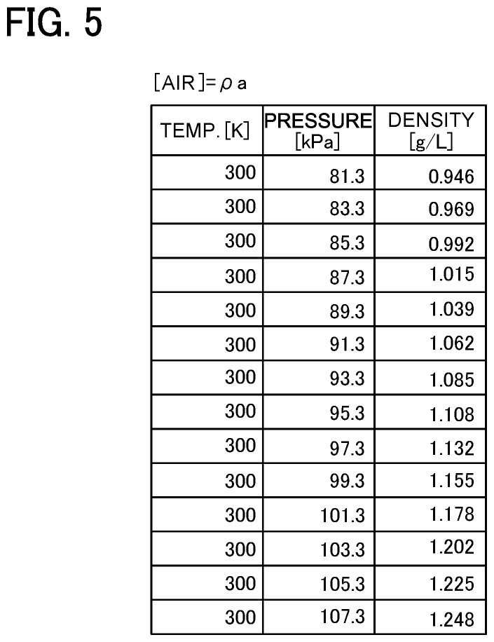

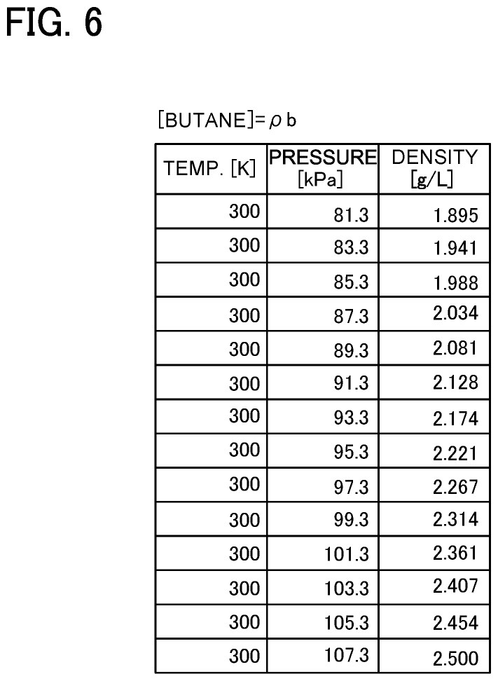

When the density pa and the density ρb are corrected from the detected absolute pressure, a determined correction formula or map is used. For example, maps indicated in FIG. 5 and FIG. 6 are used. As shown in FIGS. 5 and 6, the larger the absolute pressure (indicated as “Pressure” in the figures) is, the larger the density pa and the density ρb are corrected to be.

Subsequently, back to the explanation of FIG. 4, the purge gas concentration detection part 21 detects the pump speed by the rotation sensor 24 (step S7).

Subsequently, the purge gas concentration detection part 21 calculates a pressure Pa and a pressure Pb and corrects the pressure Pa and the pressure Pb from the detected pump speed (step S8).

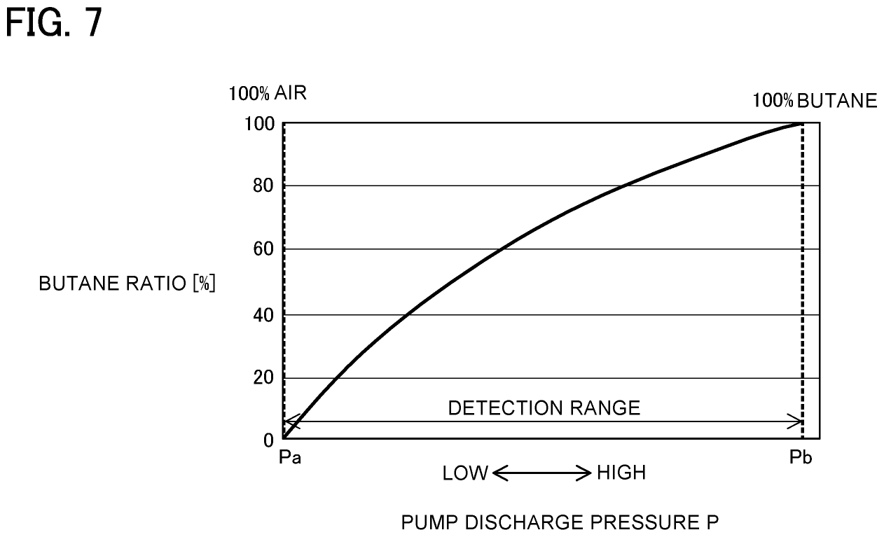

Herein, the pressure Pa and the pressure Pb represent characteristics of the pump discharge pressure P in different butane ratios stored in advance in the purge gas concentration detection part 21. For example, the pressure Pa represents the pump discharge pressure P when the butane ratio is 0% (i.e., when the air ratio is 100%), and the pressure Pb represents the pump discharge pressure P when the butane ratio is 100%. In the present example, the purge gas concentration detection part 21 calculates the pressure Pa and the pressure Pb by use of a map shown in FIG. 7, for example.

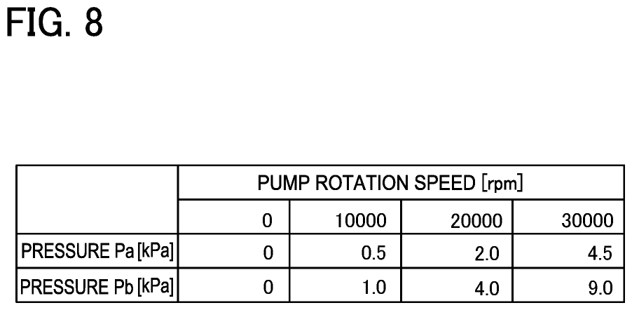

When the pressure Pa and the pressure Pb are to be corrected from the detected pump speed, a predetermined correction formula or map, for example, a map shown in FIG. 8 is used. As shown in FIG. 8, the larger the pump speed is, the larger the pressure Pa and the pressure Pb are corrected to be.

Subsequently, back to the explanation of the flowchart in FIG. 4, the purge gas concentration detection part 21 calculates concentration ρ1 of the purge gas (step S9). The concentration ρ1 is calculated by the following formulas. In the formulas, μmix represents density of mixture gas.

$$\begin{matrix}ρ mix = \frac{P mix - P}{P b - P a} \times ( ρ b - ρ a ) + ρ a & ( Formula 2 ) \\ ρ 1 = \frac{ρ b \times ( ρ mix - ρ a )}{ρ mix \times ( ρ b - ρ a )} & ( Formula 3 )\end{matrix}$$

Subsequently, the purge gas concentration detection part 21 calculates an INJ reduction amount (i.e., an injector reduction amount) Qinj from A/F_FB (i.e., an A/F feedback value) (step S10) to obtain a purge flow volume Qp (i.e., a flow volume of the purge gas) from an ECU control value (step S11). Herein, the A/F_FB represents an A/F detected value in the engine ENG (for example, a detected value of an A/F sensor that detects an oxygen concentration in exhaust gas discharged from the engine ENG). The INJ reduction amount Qinj represents a reduced amount of an injection amount of the fuel injected by the injector INJ to the engine ENG.

Subsequently, the purge gas concentration detection part 21 calculates concentration ρ2 of the purge gas from the purge flow volume Qp and the INJ reduction amount Qinj (step S12). The concentration ρ2 is calculated by the following formula. In the formula, ρp represents purge density (air) and ρinj represents fuel density.

$$ρ 2 = \frac{Q p \times ρ p}{Q inj \times ρ inj} \qquad ( Formula 4 )$$

Subsequently, the purge gas concentration detection part 21 calculates a correction coefficient CF from a ratio of the concentration ρ1′ to the concentration ρ2 (step S13). Specifically, the correction coefficient CF is obtained by the following formula.

$$C F = \frac{ρ 2}{ρ {1}^{′}} \qquad ( Formula 5 )$$

Herein, the concentration ρ2 obtained from the A/F_FB as mentioned above can be accurately calculated when the operation state of the engine ENG is under a steady state (the load of the engine ENG is unchanged and the intake air amount is unchanged) since the A/F_FB is stable, but when the operation state of the engine ENG is under an excessive state, the concentration cannot be accurately calculated due to the unstable A/F_FB. In most of the time, the operation state of the engine ENG is in the excessive state, and thus accurate calculation of the concentration ρ2 is impossible in the excessive state which largely accounts for the operation state of the engine ENG. To address this problem, in the present embodiment, the concentration ρ2 represented by the formula 4 is calculated under the steady state of the operation state of the engine ENG, and the correction coefficient CF represented by the formula 5 is further learned. In the formula 5, the concentration ρ1′ is the concentration ρ1 that is calculated by the formula 2 and the formula 3 in learning the correction coefficient CF (namely, in the steady state of the operation state of the engine ENG), and this concentration ρ1′ is calculated at a timing different from the concentration ρ1 described in the following formula 6.

Subsequently, the purge gas concentration detection part 21 calculates a concentration wt of the purge gas from the pump discharge pressure including the correction coefficient CF (step S14). Specifically, the purge gas concentration detection part 21 detects the concentration wt of the purge gas from a detected value Pmix of the pump discharge pressure detected by the pressure sensor 22 by use of this correction coefficient CF. The purge gas concentration wt is calculated by the above-mentioned formula 2 and the following formula.

$$w t = CF \times \frac{ρ b \times ( ρ mix - ρ a )}{ρ mix \times ( ρ b - ρ a )} = CF \times ρ1 \qquad ( Formula 6 )$$

As mentioned above, after learning the correction coefficient CF that is represented by the formula 5 when the operation state of the engine ENG is in the steady state, calculation of the purge gas concentration wt that is represented in the formula 6 including the correction coefficient CF is carried out irrespective of the operation state of the engine ENG under any one of the steady state and the excessive state. Accordingly, the accurate calculation of the purge gas concentration wt is achieved irrespective of the operation state of the engine ENG under any one of the steady state and the excessive state.

Thus, the purge gas concentration detection part 21 calculates the purge gas concentration wt from the detected value Pmix of the pump discharge pressure with reference to two points in a concentration range of butane that is common fuel component included in the purge gas.

In other words, the purge gas concentration detection part 21 calculates concentration ρ1 of the purge gas from the characteristics of the purge gas density ρ with respect to two butane ratios stored in advance (specifically, the density ρa and the density ρb), the characteristics of the pump discharge pressure P (specifically, the pressure Pa and the pressure Pb), and the detected value Pmix of the pump discharge pressure. Then, the purge gas concentration detection part 21 further calculates the concentration wt of the purge gas by correcting the thus calculated concentration ρ1 of the purge gas based on the correction coefficient CF that is calculated based on the A/F_FB in the engine ENG.

The controller 17 then controls an open degree of the purge valve 14 and the pump speed of the purge pump 13 during execution of the purge control based on the calculated purge gas concentration wt mentioned above.

In the above explanation, two butane ratios (namely, 0% (a first predetermined ratio) and 100% (a second predetermined ratio)) are set, but alternatively, three or more ratios may be set.

The purge gas concentration detection part 21 corrects the density ρa, the density ρb, the pressure Pa, and the pressure Pb from the absolute pressure and the pump speed, and after that, the detection part 21 performs correction based on the A/F_FB value in the engine ENG. As mentioned above, the correction operation is not performed before correcting the density ρa, the density ρb, the pressure Pa, and the pressure Pb from the absolute pressure and the pump speed based on the A/F_FB value in the engine ENG, so that there is no possibility of wrongly correcting the pump speed and others by wrongly judges changes in the pump speed and others as variations in gas components.

### (Low Purge-Gas-Concentration Region)

In a region where the concentration of the purge gas is low, when an absolute value of 1% of the concentration is wrongly detected as 2%, for example, the concentration of the purge gas could be determined to be doubled in error. This could lead to control of the doubled INJ reduction amount, which may largely affect A/F control performance of a vehicle. To address this, the controller 17 disallows control of the open degree of the purge valve 14 and the pump speed of the purge pump 13 based on the purge gas concentration in a case where the purge gas concentration is equal to or less than a predetermined concentration (10% or less, for instance). At this time, the controller 17 further sets a limit to an upper limit of the INJ reduction amount.

### (Explanation for Time Chart)

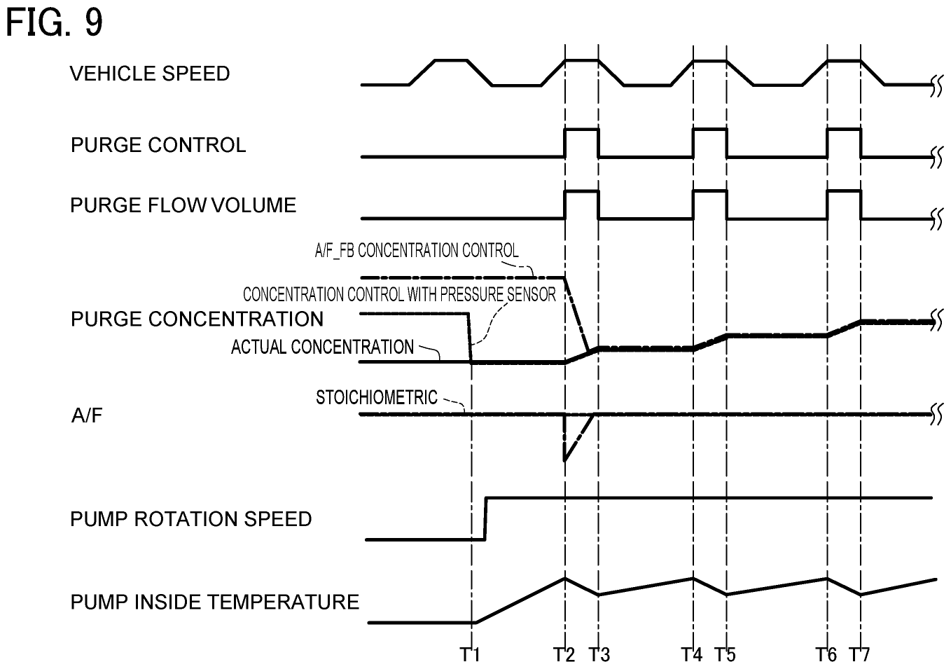

FIG. 9 shows a time chart indicating one example of a control operation performed in the present embodiment.

As shown in FIG. 9, a concentration control based on a conventional A/F_FB value as indicated with a chain-dot line in the figure has mal-responsibility as for the concentration of the purge gas (indicated as “purge concentration” in the figure) when the purge control has started at time T2, and the A/F ratio is deviated from a stoichiometric ratio and disturbed until the concentration is stabilized to an accurate value. Therefore, in order not to disturb the A/F ratio, there is needed to control the purge flow volume to be reduced at the time of starting the purge control.

On the other hand, in the present embodiment performing the concentration control by use of the pressure sensor 22, the purge gas concentration can be accurately obtained before start of the purge control (for example, from time T1) as indicated with a broken line in FIG. 9, and thus the A/F ratio is not deviated from the stoichiometric ratio and not disturbed at time T2 when the purge control is started. Therefore, there is no need to control the purge flow volume to be reduced at the time of starting the purge control.

### Second Example

A second example is now explained with focus on different points from the first example.

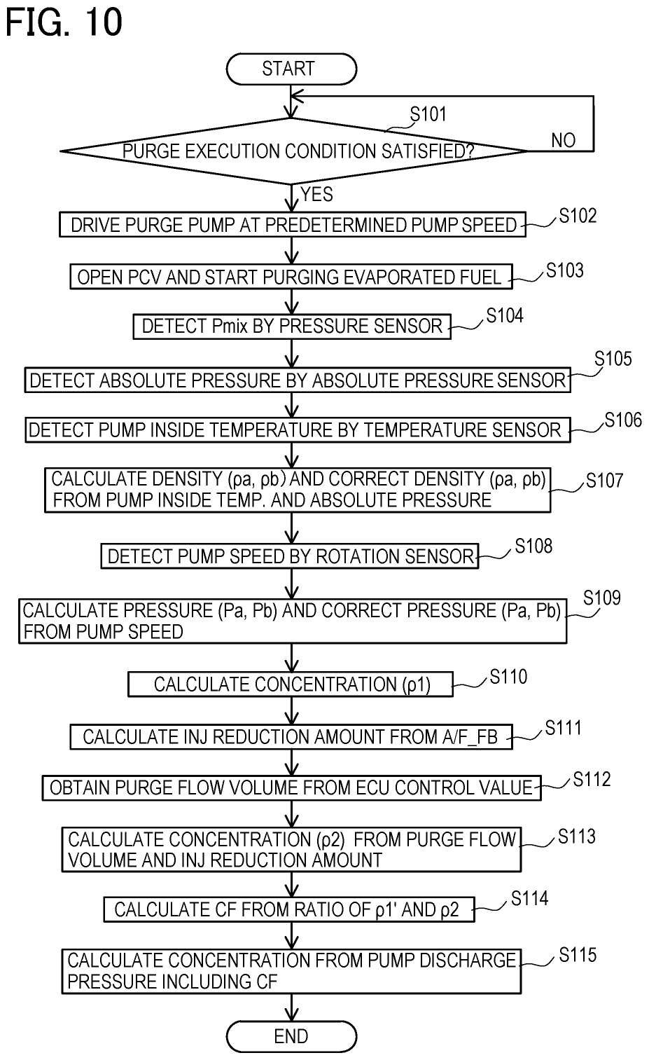

In the present example, the concentration ρ1 of the purge gas is calculated in consideration with the pump inside temperature. Specifically, as shown in FIG. 10, the purge gas concentration detection part 21 detects the pump inside temperature by the temperature sensor 23 (step S106). Subsequently, the purge gas concentration detection part 21 calculates the density ρa and the density ρb and corrects the density ρa and the density ρb from the detected pump inside temperature and the absolute pressure (step S107). After that, the purge gas concentration detection part 21 utilizes the thus corrected density ρa and the density ρb to calculate the purge concentration ρ1 (step S110).

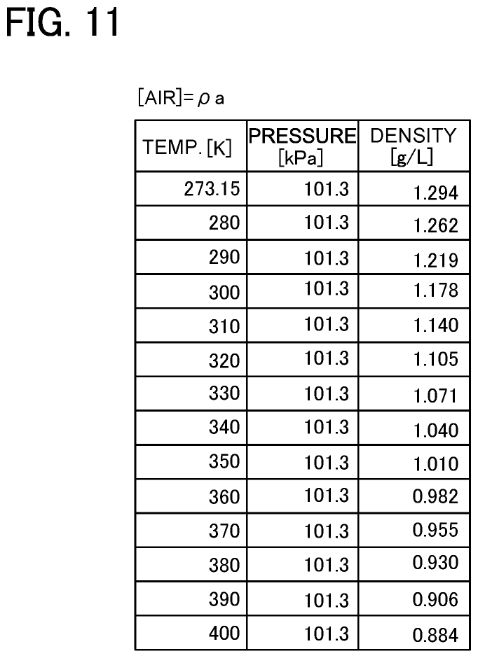

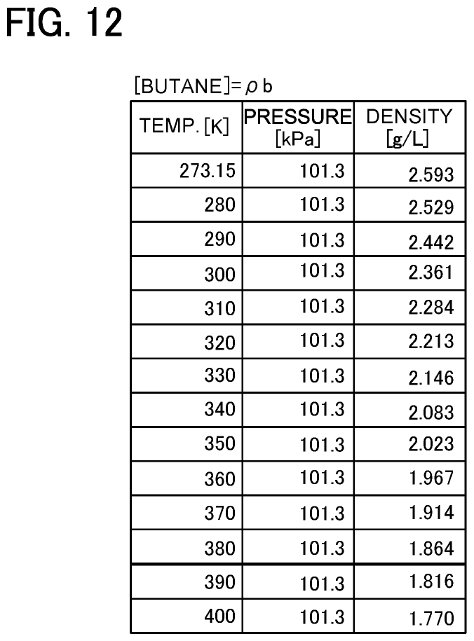

When the density ρa and the density ρb are to be corrected from the detected pump inside temperature and the absolute pressure, a predetermined correction formula or map is used. For example, maps shown in FIG. 11 and FIG. 12 are used. As shown in FIGS. 11 and 12, the density ρa and the density ρb are corrected to become smaller as the pump inside temperature (indicated as “Temperature” in the figure) increases.

As above, in the present example, the purge gas concentration detection part 21 corrects the purge gas concentration ρ1 based on the pump inside temperature. Back to the explanation in FIG. 10, subsequently, the purge gas concentration detection part 21 utilizes the thus corrected purge gas concentration ρ1 to calculate the purge gas concentration wt (step S115). Specifically, the purge gas concentration detection part 21 corrects the purge gas concentration wt based on the pump inside temperature.

### (Estimation of Pump Inside Temperature)

In step S106, the pump inside temperature may be estimated by a pump inside temperature estimation part 26 provided in the evaporated fuel treatment apparatus 1 instead of the temperature sensor 23 as mentioned below.

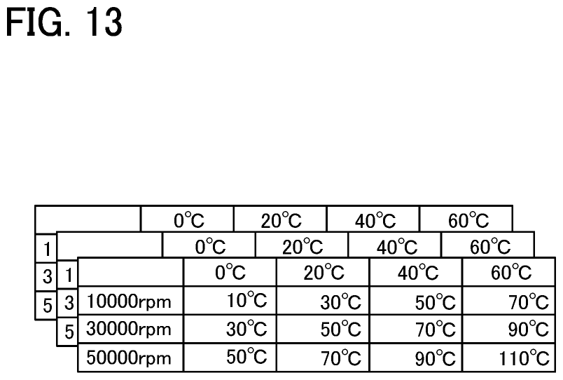

During halt of purging (namely, during halt of the purge control), a pump inside temperature T is calculated and estimated by the following formula with the ambient temperature, a heat generation amount (the square of the pump speed), and a driving time of the purge pump 13. In the following formula, Ti represents an initial temperature of the pump inside temperature, and initially, the ambient temperature is substituted for Ti. Too represents a pump hardware temperature (namely, a temperature of a housing of the purge pump 13), and is expressed by the following formulas. A relation among the pump hardware temperature Too, the ambient temperature, the heat generation amount (the pump speed), and the driving time t of the purge pump 13 is experimentally examined and formed into a map (see FIG. 13, for example). Ca represents an experimental coefficient and is expressed by the following formula by a heat conductive rate h, a surface area S, and a heat capacity C.

T=(Ti−T∞)e^{Ca·t}+T∞ (Formula 7)

Ca=(h×s)/C (Formula 8)

T∞=(Ambient Temperature)×(Pump Heat Generation Amount)×Function of Driving Time t (Formula 9)

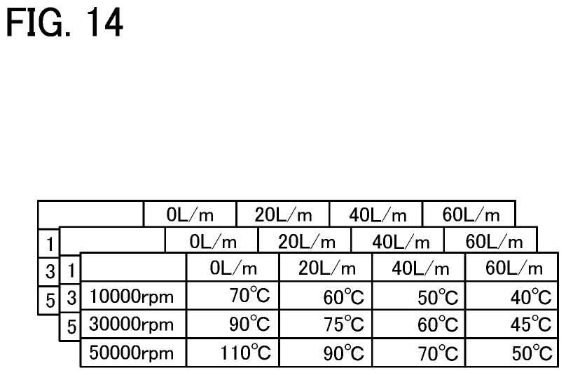

Further, during purging (namely, during execution of the purge control), the pump inside temperature T is calculated to be estimated by use of the above formula from the purge flow volume, the heat generation amount (pump speed), and the driving time of the purge pump 13 with reference to the pump inside temperature during halt of the purge control. Herein, the pump hardware temperature T∞ is represented by the following formula. The relation among the pump hardware temperature Too, the purge flow volume, the heat generation amount (the pump speed), and the driving time t of the purge pump 13 is experimentally examined to form into a map (see FIG. 14, for example).

T∞=(Purge Flow Volume)×(Pump Heat Generation Amount)×Function of Driving Time t (Formula 10)

As mentioned above, the evaporated fuel treatment apparatus 1 may include the pump inside temperature estimation part 26 to estimate the pump inside temperature (specifically, a temperature inside the volute chamber 13e of the purge pump 13) from the operation information of the purge pump 13 (for example, the purge pump speed and the driving time t of the purge pump 13, as well as the ambient temperature, the purge flow volume, and others).

### Third Example

A third example is now explained with focus on different points from the second example.

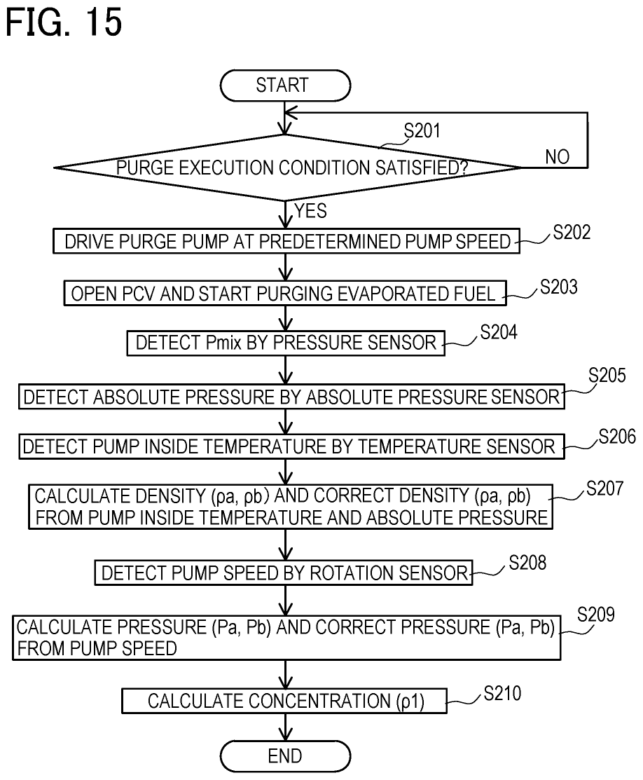

In the present example, as shown in FIG. 15, the purge gas concentration detection part 21 takes into consideration with the pump inside temperature (steps S206, S207) as similar to the second example and calculates the purge gas concentration ρ1 (step S210). The controller 17 controls the open degree of the purge valve 14 and the pump speed of the purge pump 13 during the purge control based on the thus calculated purge gas concentration ρ1. In this manner, in the present example, the purge gas concentration detection part 21 corrects the purge gas concentration p 1 based on the pump inside temperature.

### (Operations and Effects of Embodiment)

In the present embodiment, the purge gas concentration detection part 21 calculates the purge gas concentration ρ1 from the characteristics (the density ρa and the density ρb) of the density ρ of the purge gas and the characteristics (the pressure Pa and the pressure Pb) of the pump discharge pressure P with respect to two butane ratios stored in advance, and the detected value Pmix of the pump discharge pressure detected by the pressure sensor 22, and corrects the purge gas concentration ρ1 based on the A/F detected value in the engine ENG to calculate the purge gas concentration wt. Based on this purge gas concentration wt, the controller 17 controls the open degree of the purge valve 14 and the pump speed of the purge pump 13 during execution of the purge control.

As mentioned above, in the present embodiment, the concentration is calculated from the detected value Pmix of the pump discharge pressure with reference to two points in a butane concentration range. For example, the purge gas concentration ρ1 is calculated from the density ρa and the pressure Pa in a case of the butane ratio of 0%, the density ρb and the pressure Pb in a case of the butane ratio of 100%, those of which are stored in advance in the purge gas concentration detection part 21, and the detected value Pmix of the pump discharge pressure. By using the density ρ and the pump discharge pressure P with reference to the above-mentioned butane ratio, the purge gas concentration is calculated by the density ρ and the pump discharge pressure P which are in a prescribed proportional relation, thereby improving the detection accuracy of the purge gas concentration.

Further, in the present embodiment, the purge gas concentration is corrected based on the A/F detected value in the engine ENG. This correction operation makes it possible to reduce a gap between the purge gas concentration calculated from the density ρ and the pump discharge pressure P with reference to the butane ratio and the actual concentration of the purge gas including fuel components other than butane, thereby further improving the detection accuracy of the purge gas concentration. Therefore, controlling the purge valve 14 and the purge pump 13 based on the detected purge gas concentration makes it possible to control the purge valve 14 based on the actual purge gas, and accordingly, the A/F disturbance (namely, disturbance in the air-fuel ratio in which the air-fuel ratio in a combustion chamber (not shown) of the engine ENG excessively fluctuates) can be hardly generated. Therefore, controllability of the A/F ratio is improved and the flow volume of the purge gas to be introduced into the engine ENG is increased, so that generation of evaporative emission can be restrained.

Further, the purge gas concentration detection part 21 may correct the purge gas concentration ρ1 based on the pump inside temperature. Thus, the purge gas concentration can be detected in consideration with influence of changes in the purge gas density ρ due to changes in the pump inside temperature, thereby improving the detection accuracy of the purge gas concentration. Further, even when operation of flowing and not-flowing of the purge gas in the purge passage 12 is repeated, the pump inside temperature is hardly influenced by this repetition, and thus the detection accuracy of the purge gas concentration is improved. At the start of flowing the purge gas (namely, when the purge gas starts to flow from the purge pump 13 in starting (or restarting) the purge control), the amount of the evaporated fuel included in the purge gas can be accurately obtained, so that generation of the A/F disturbance can be restrained and a large amount of the purge gas can be introduced into the engine ENG. Thus, the controller 17 can control the flow volume of the purge gas at the start of flowing of the purge gas to a large extent.

Further, when the purge gas concentration wt or the purge gas concentration ρ1 is a predetermined concentration or less, the controller 17 may disallow controlling the open degree of the purge valve 14 and the pump speed of the purge pump 13 during execution of the purge control based on the purge gas concentration wt or the purge gas concentration ρ1. Thus, there is hardly occurred the A/F disturbance in a region where the purge gas concentration is low in which the detection accuracy of the purge gas concentration could be low.

Further, when the purge gas concentration wt is the predetermined concentration or less, the controller 17 provides a limit to an upper limit of the INJ reduction amount, so that the A/F disturbance is further effectively hardly occurred.

Further, the evaporated fuel treatment apparatus 1 may be provided with the pump inside temperature estimation part 26 to estimate the pump inside temperature form the operation information of the purge pump 13.

Accordingly, the pump inside temperature can be detected without providing the temperature sensor 23 in the purge pump 13. Therefore, the configuration of the purge pump 13 can be simplified, thus achieving cost reduction.

Further, the controller 17 may perform calibration of the detected value Pmix of the pump discharge pressure detected by the pressure sensor 22 based on the P-Q characteristics of the purge pump 13 under a state in which the purge gas concentration calculated from the A/F detected value in the engine ENG is almost zero.

Accordingly, even when there is occurred individual differences and secular changes in the pressure sensor 22, the precision of the detected value Pmix of the pump discharge pressure detected by the pressure sensor 22 can be maintained, so that the detection accuracy of the purge gas concentration is stabilized.

### Second Embodiment

A second embodiment is now explained with focus on different points from the first embodiment.

### <Overall Configuration of System>

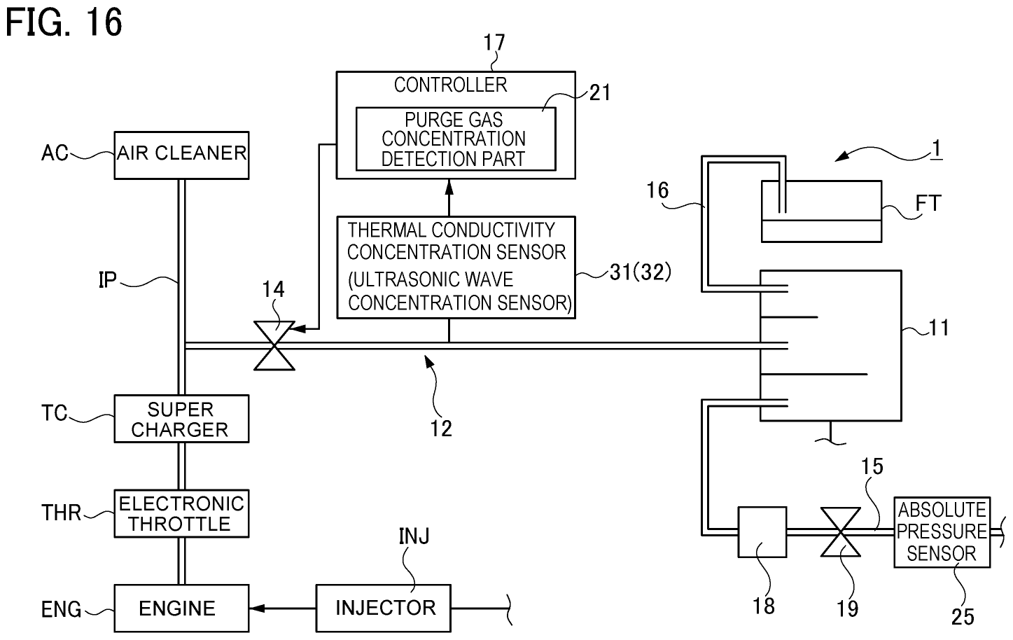

In the present embodiment, as shown in FIG. 16, the evaporated fuel treatment apparatus 1 includes no purge pump 13 but includes a thermal conductivity concentration sensor 31 or an ultrasonic wave concentration sensor 32 provided in the purge passage 12. Further, in the present example, the purge gas concentration ρ1 is calculated by a detected value detected by the thermal conductivity concentration sensor 31 or the ultrasonic wave concentration sensor 32.

The thermal conductivity concentration sensor 31 is a thermal conductive type sensor for detecting gas concentration based on changes in thermal conductivity in objective gas to be detected. To be specific, the thermal conductivity concentration sensor 31 is provided with a detection element and a compensation element, and when a temperature of the detection element is changed by contacting with the gas to be detected, this change in the temperature leads to change in a resistance value of a platinum wire coil configuring the detection element in almost proportion to the gas concentration, thereby the sensor 31 detects this change in the resistance value as a voltage though a bridge circuit and obtain the gas concentration based on the thus detected voltage.

Further, the ultrasonic wave concentration sensor 32 is an ultrasonic-wave type sensor to detect the gas concentration based on changes in sonic speed by the objective gas to be detected. To be specific, the ultrasonic wave concentration sensor 32 is provided with a transmission sensor and a receiving sensor, and the sensor 32 measures a period of time from transmission of the ultrasonic wave transmitted from the transmission sensor to reaching at the receiving sensor through the gas, detects the sonic speed in consideration with a distance between the known sensors, further detects the temperature, and thus obtains the gas concentration based on the mean molecular weight obtained from the detected sonic speed and the temperature.

### <Method of Detecting Purge Gas Concentration>

### (Explanation of Flowchart Showing Method of Detecting Purge Gas Concentration)

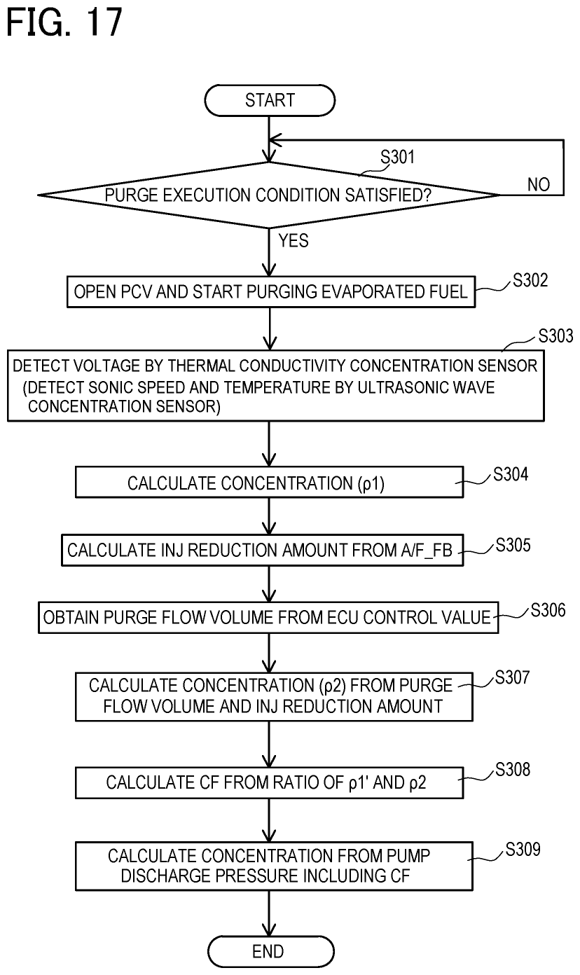

In the present embodiment, the purge gas concentration is detected based on the contents of a flowchart shown in FIG. 17, and a purge control is carried out based on the detected purge gas concentration. As shown in FIG. 17, when a purging execution condition is satisfied (step S301: YES), the controller opens the purge valve 14 and starts purging the evaporated fuel (step S302).

Subsequently, the purge gas concentration detection part 21 detects the voltage from the thermal conductivity concentration sensor 31 or detects the sonic speed and the temperature by the ultrasonic wave concentration sensor 32 (step S303), and calculates the purge gas concentration ρ1 based on the detected value detected in the step S303 (step S304).

Subsequently, the purge gas concentration detection part 21 calculates the INJ reduction amount Qinj from A/F_FB (step S305) and obtains the purge flow volume Qp from the ECU control value (step S306). The purge gas concentration detection part 21 then calculates the purge gas concentration ρ2 from the purge flow volume Qp and the INJ reduction amount Qinj as similar to the above-mentioned step S12 (step S307).

Subsequently, the purge gas concentration detection part 21 calculates the correction coefficient CF from a ratio of the concentration p 1′ to the concentration ρ2 as similar to the above-mentioned step S13 (step S308).

Subsequently, the purge gas concentration detection part 21 calculates the purge gas concentration wt from the detected value detected by the sensor including the correction coefficient CF (the detected value detected by the thermal conductivity concentration sensor 31 or the ultrasonic wave concentration sensor 32) (step S309). In other words, the purge gas concentration detection part 21 detects the purge gas concentration wt from the detected value detected by the thermal conductivity concentration sensor 31 or the ultrasonic wave concentration sensor 32 by use of the correction coefficient CF.

As mentioned above, the purge gas concentration detection part 21 calculates the purge gas concentration ρ1 from the detected value of the thermal conductivity concentration sensor 31 or the ultrasonic wave concentration sensor 32. The purge gas concentration detection part 21 then corrects the calculated purge gas concentration ρ1 based on the correction coefficient CF that is calculated based on A/F_FB in the engine ENG to detect the purge gas concentration wt.

The controller 17 controls the open degree of the purge valve 14 during execution of the purge control based on the thus calculated purge gas concentration wt.

Herein, when the purge gas concentration wt is a predetermined concentration or less (10% or less, for example), the controller 17 may disallow control of the open degree of the purge valve 14 during execution of the purge control based on the purge gas concentration wt. Further at this time, the controller 17 may set a limit to an upper limit of the INJ reduction amount.

### Modified Example

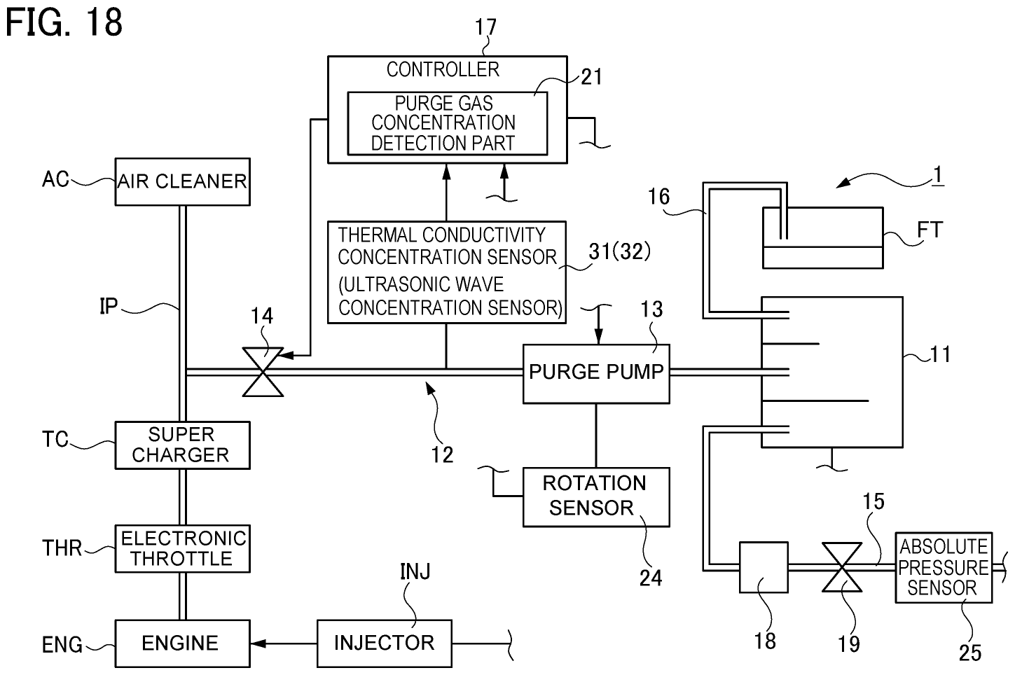

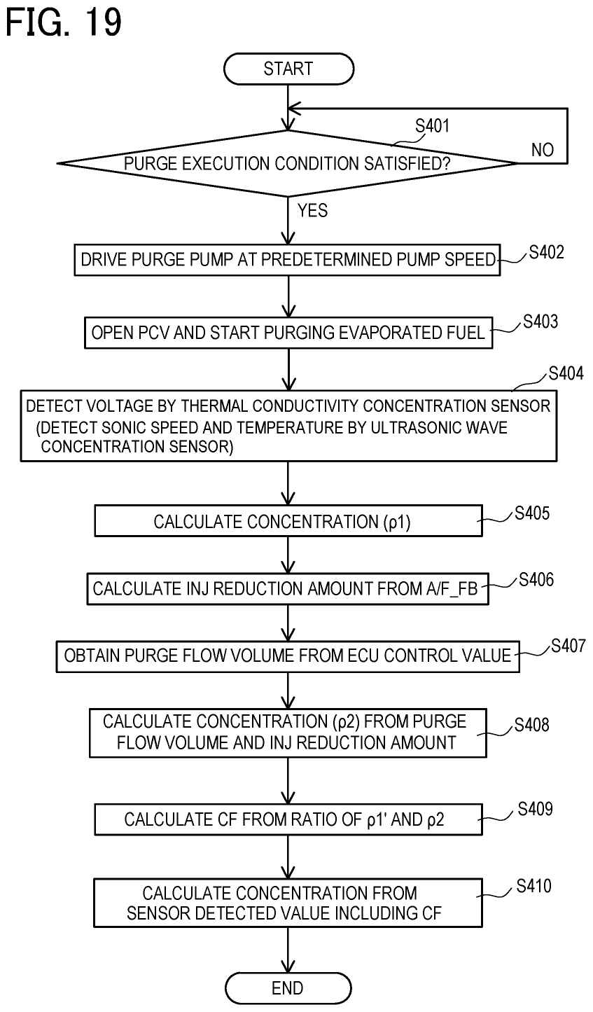

As a modified example, the evaporated fuel treatment apparatus 1 may be provided with the purge pump 13 as shown in FIG. 18. In this modified example, the purge gas concentration is detected based on an operation indicated in a flowchart of FIG. 19, and the purge control is carried out based on the thus detected purge gas concentration. As shown in FIG. 19, when the purging operation condition is satisfied (step S401: YES), the controller 17 drives the purge pump 13 at a predetermined rotation speed (step S402), which is different from the example shown in FIG. 17. Other processing is common with that shown in FIG. 17, and thus explanation thereof is omitted. The controller 17 subsequently controls both the open degree of the purge valve 14 and the rotation speed of the purge pump 13 during prosecution of the purge control based on the detected purge gas concentration wt as shown in FIG. 19.

<Operations and Effects of Present Embodiment>

In the present embodiment, the purge gas concentration detection part 21 calculates the purge gas concentration ρ1 from the detected value detected by the thermal conductivity concentration sensor 31 or the ultrasonic wave concentration sensor 32 and corrects the calculated purge gas concentration p 1 based on the A/F detected value in the engine ENG to detect the purge gas concentration wt. The controller 17 then controls the open degree of the purge valve 14 or both the open degree of the purge valve 14 and the rotation speed of the purge pump 13 during execution of the purge control based on the purge gas concentration wt detected by the purge gas concentration detection part 21.

In this manner, in the present embodiment, the purge gas concentration p 1 is calculated from the detected value of the thermal conductivity concentration sensor 31 or the ultrasonic wave concentration sensor 32. The purge gas concentration ρ1 of the present embodiment is further corrected based on the A/F detected value in the engine ENG. Thus, the purge gas concentration ρ1 calculated from the detected value of the thermal conductivity concentration sensor 31 or the ultrasonic wave concentration sensor 32 and the actual purge gas concentration has less differences, so that the detection accuracy of the purge gas concentration wt can further be improved. Accordingly, the control of the purge valve 14 based on the actual purge gas is possible according to the detected purge gas concentration wt, thereby restraining occurrence of the A/F disturbance. Therefore, the controllability of the A/F is improved, and the flow volume of the purge gas to be introduced into the engine ENG is increased, resulting in suppression of generation of evaporative emission.

The above-mentioned embodiment is only an illustration of the present disclosure and gives no any limitation to the present disclosure, and various changes and modifications may be made without departing from the scope of the disclosure.

For example, when changes in the temperature of the intake air in the intake passage IP or changes in the temperature of the fuel in the fuel tank FT is small, changes in components of the purge gas is estimated to be small. This case seems to have less requirements of controlling the open degree of the purge valve 14 during execution of the purge control based on the purge gas concentration wt detected by the purge gas concentration detection part 21.

Accordingly, the controller 17 may discontinue controlling the open degree of the purge valve in a case where the changes in the temperature of the intake air in the intake passage IP has been within a predetermined range (for example, 0° C. to 5° C.) for a certain period of time (for example, for 1 hour) or in a case where the changes in the temperature of the fuel in the fuel tank FT has been within a predetermined range (for example, 0° C. to 5° C.) for a certain period of time (for example, for 1 hour). Namely, the controller 17 may discontinue controlling the open degree of the purge valve 14 during execution of the purge control based on the purge gas concentration wt detected by the purge gas concentration detection part 21. Thus, consumption of the driving power of the purge valve 14 can be suppressed, thereby reducing the required electricity.

Further, the controller 17 may restart controlling the open degree of the purge valve 14 in a case where the changes in the intake temperature in the intake passage IP exceeds the predetermined rage or in a case where the changes in the in the fuel temperature in the fuel tank FT exceeds the predetermined range. Namely, the controller 17 may restart controlling the open degree of the purge valve 14 during execution of the purge control based on the purge gas concentration wt detected by the purge gas concentration detection part 21. This achieves suppression of occurrence of the A/F disturbance.

Further, for example, the density ρa may be the density ρ of the purge gas when the butane ratio is other than 0%, and the density ρb may be the density ρ of the purge gas when the butane ratio is other than 100%. Similarly, the pressure Pa may be the pump discharge pressure P when the butane ratio is other than 0%, and the pressure Pb may be the pump discharge pressure P when the butane ratio is other than 100%.

Further, the pressure sensor 22 may detect a front-rear pressure difference as a pressure difference between an outlet pressure and an inlet pressure of the purge pump 13, and the purge gas concentration detection part 21 may calculate the purge gas concentration from the detected value of the front-rear pressure difference of the purge pump 13 detected by the pressure sensor 22. The front-rear pressure difference of the purge pump 13 corresponds to one example of a “pump pressure” of the present disclosure.

### REFERENCE SIGNS LIST

1 Evaporated fuel treatment apparatus
11 Canister
12 Purge passage
13 Purge pump
13e Volute chamber
14 Purge valve
17 Controller
21 Purge gas concentration detection part
22 Pressure sensor
23 Temperature sensor
24 Rotation sensor
25 Absolute pressure sensor
26 Pump inside temperature estimation part
31 Thermal conductivity concentration sensor
32 Ultrasonic wave concentration sensor
ENG Engine
INJ Injector
IP Intake passage
FT Fuel tank
ρ Density (of purge gas)
ρa Density (when butane ratio is 0%)
ρb Density (when butane ratio is 100%)
P Pump discharge pressure
Pmix Detected value of the pump discharge pressure
Pa Pressure (when butane ratio is 0%)
Pb Pressure (when butane ratio is 100%)
ρ1, ρ1′ Concentration
Qinj INJ reduction amount
ρ2 Concentration
CF Correction coefficient
wt Concentration of purge gas
T Pump inside temperature

What is claimed is:

1. An evaporated fuel treatment apparatus comprising:
a canister configured to store evaporated fuel;
a purge passage configured to make purge gas including the evaporated fuel flow from the canister to an engine;
a purge valve configured to open and close the purge passage; and
a controller configured to drive the purge valve to execute purge control of introducing the purge gas into the engine through the purge passage and an intake passage from the canister, wherein
the evaporated fuel treatment apparatus includes a purge gas concentration detection part to detect a concentration of the purge gas,
the purge gas concentration detection part calculates the concentration of the purge gas and detects the purge gas concentration by correcting the calculated concentration of the purge gas based on an A/F detected value in the engine, and
the controller controls an open degree of the purge valve during execution of the purge control based on the concentration of the purge gas that is detected by the purge gas concentration detection part.

2. The evaporated fuel treatment apparatus according to claim 1, wherein
the evaporated fuel treatment apparatus comprises:
a purge pump configured to feed the purge gas to the intake passage; and
a pump pressure detection part to detect a pump pressure as any one of a discharge pressure and a front-rear pressure difference of the purge pump, wherein
the purge gas concentration detection part calculates the concentration of the purge gas from density characteristics of the purge gas and characteristics of the pump pressure with respect to a plurality of specified fuel component ratios that have been stored in advance, the specified fuel component ratio being defined by a ratio of a specified component of the evaporated fuel included in the purge gas, and from a detected value of the pump pressure detected by the pump pressure detection part,
the controller carries out the purge control by driving the purge pump and the purge valve, and
the controller controls an open degree of the purge valve and a pump speed of the purge pump during execution of the purge control based on the concentration of the purge gas that is detected by the purge gas concentration detection part.

3. The evaporated fuel treatment apparatus according to claim 2, wherein the purge gas concentration detection part is configured to correct the calculated concentration of the purge gas based on a pump inside temperature that is a temperature inside the purge pump.

4. An evaporated fuel treatment apparatus comprising:
a canister configured to store evaporated fuel;
a purge passage configured to make purge gas including the evaporated fuel flow from the canister to an engine;
a purge pump configured to feed the purge gas to an intake passage;
a purge valve configured to open and close the purge passage; and
a controller configured to drive the purge pump and the purge valve to execute purge control of introducing the purge gas to the engine through the purge passage and the intake passage from the canister, wherein
the evaporated fuel treatment apparatus includes:
a pump pressure detection part to detect a pump pressure as any one of a discharge pressure and a front-rear pressure difference of the purge pump; and
a purge gas concentration detection part to detect concentration of the purge gas,
the purge gas concentration detection part calculates the concentration of the purge gas from a detected value of the pump pressure detected by the pump pressure detection part,
the purge gas concentration detection part detects the concentration of the purge gas by correcting the calculated concentration of the purge gas based on a pump inside temperature that is a temperature inside the purge pump, and
the controller controls an open degree of the purge valve and a pump speed of the purge pump during execution of the purge control based on the concentration of the purge gas that is detected by the purge gas concentration detection part.

5. The evaporated fuel treatment apparatus according to claim 1, wherein the controller disallows controlling the open degree of the purge valve or both the open degree of the purge valve and the pump speed of the purge pump during execution of the purge control based on the concentration of the purge gas when the concentration of the purge gas is equal to or less than a predetermined concentration.

6. The evaporated fuel treatment apparatus according to claim 5, wherein the controller sets an upper limit to a reduction rate of an injection amount of an injector that is configured to inject fuel into the engine.

7. The evaporated fuel treatment apparatus according to claim 3 comprising a pump inside temperature estimation part to estimate the pump inside temperature from an operation information of the purge pump.

8. The evaporated fuel treatment apparatus according to claim 2, wherein the controller is configured to calibrate a detected value of the pump pressure detected by the pump pressure detection part based on the P-Q characteristics of the purge pump under a state in which the concentration of the purge gas calculated from an A/F detected value in the engine is almost zero.

9. The evaporated fuel treatment apparatus according to claim 1, wherein the purge gas concentration detection part is configured to calculate the concentration of the purge gas from a detected value of any one of a thermal conductive type sensor and an ultrasonic-wave type sensor.

10. The evaporated fuel treatment apparatus according to claim 1, wherein
the controller is configured to:
discontinue controlling the open degree of the purge valve when any one of changes in a temperature of intake air in the intake passage and changes in a temperature of fuel in a fuel tank are within a predetermined range during a certain period of time; and
restart controlling the open degree of the purge valve when any one of the changes in the temperature of the intake air in the intake passage and the changes in the temperature of the fuel in the fuel tank exceed the predetermined range.

11. The evaporated fuel treatment apparatus according to claim 2, wherein the controller disallows controlling the open degree of the purge valve or both the open degree of the purge valve and the pump speed of the purge pump during execution of the purge control based on the concentration of the purge gas when the concentration of the purge gas is equal to or less than a predetermined concentration.

12. The evaporated fuel treatment apparatus according to claim 2, wherein
the controller is configured to:
discontinue controlling the open degree of the purge valve when any one of changes in a temperature of intake air in the intake passage and changes in a temperature of fuel in a fuel tank are within a predetermined range during a certain period of time; and
restart controlling the open degree of the purge valve when any one of the changes in the temperature of the intake air in the intake passage and the changes in the temperature of the fuel in the fuel tank exceed the predetermined range.

13. The evaporated fuel treatment apparatus according to claim 3, wherein the controller disallows controlling the open degree of the purge valve or both the open degree of the purge valve and the pump speed of the purge pump during execution of the purge control based on the concentration of the purge gas when the concentration of the purge gas is equal to or less than a predetermined concentration.

14. The evaporated fuel treatment apparatus according to claim 3, wherein
the controller is configured to:
discontinue controlling the open degree of the purge valve when any one of changes in a temperature of intake air in the intake passage and changes in a temperature of fuel in a fuel tank are within a predetermined range during a certain period of time; and
restart controlling the open degree of the purge valve when any one of the changes in the temperature of the intake air in the intake passage and the changes in the temperature of the fuel in the fuel tank exceed the predetermined range.

15. The evaporated fuel treatment apparatus according to claim 4, wherein the controller disallows controlling the open degree of the purge valve or both the open degree of the purge valve and the pump speed of the purge pump during execution of the purge control based on the concentration of the purge gas when the concentration of the purge gas is equal to or less than a predetermined concentration.

16. The evaporated fuel treatment apparatus according to claim 4 comprising a pump inside temperature estimation part to estimate the pump inside temperature from an operation information of the purge pump.

17. The evaporated fuel treatment apparatus according to claim 4, wherein the controller is configured to calibrate a detected value of the pump pressure detected by the pump pressure detection part based on the P-Q characteristics of the purge pump under a state in which the concentration of the purge gas calculated from an A/F detected value in the engine is almost zero.

18. The evaporated fuel treatment apparatus according to claim 4, wherein
the controller is configured to:
discontinue controlling the open degree of the purge valve when any one of changes in a temperature of intake air in the intake passage and changes in a temperature of fuel in a fuel tank are within a predetermined range during a certain period of time; and
restart controlling the open degree of the purge valve when any one of the changes in the temperature of the intake air in the intake passage and the changes in the temperature of the fuel in the fuel tank exceed the predetermined range.

19. The evaporated fuel treatment apparatus according to claim 5, wherein
the controller is configured to:
discontinue controlling the open degree of the purge valve when any one of changes in a temperature of intake air in the intake passage and changes in a temperature of fuel in a fuel tank are within a predetermined range during a certain period of time; and
restart controlling the open degree of the purge valve when any one of the changes in the temperature of the intake air in the intake passage and the changes in the temperature of the fuel in the fuel tank exceed the predetermined range.

20. The evaporated fuel treatment apparatus according to claim 6, wherein
the controller is configured to:
discontinue controlling the open degree of the purge valve when any one of changes in a temperature of intake air in the intake passage and changes in a temperature of fuel in a fuel tank are within a predetermined range during a certain period of time; and
restart controlling the open degree of the purge valve when any one of the changes in the temperature of the intake air in the intake passage and the changes in the temperature of the fuel in the fuel tank exceed the predetermined range.
